(19) United States
(12) Patent Application Publication
(10) Pub. No.: US 2025/0016629 A1
(43) Pub. Date: Jan. 9, 2025

(54) METHODS AND DEVICES FOR USER EQUIPMENT TRANSMITTING USER EQUIPMENT INFORMATION

(71) Applicant: ZTE Corporation, Shenzhen (CN)

(72) Inventors: Yan XUE, Shenzhen (CN); Bo DAI, Shenzhen (CN); Feng XIE, Shenzhen (CN)

(73) Assignee: ZTE Corporation, Shenzhen (CN)

(21) Appl. No.: 18/892,746

(22) Filed: Sep. 23, 2024

Related U.S. Application Data
(63) Continuation of application No. PCT/CN2022/109487, filed on Aug. 1, 2022.

(51) Int. Cl. H04W 28/24; H04L 1/20

(52) U.S. Cl. CPC H04W 28/24; H04L 1/203

(57) ABSTRACT

The present disclosure describes methods, system, and devices for a user equipment (UE) transmitting UE information. One method includes transmitting, by a UE, UE information to a base station, wherein the UE information comprises at least one of the following: UE transmission status information, UE uplink QoS information, or UE application layer information. Another method includes receiving, by a base station, UE information from a UE, the UE information configured to assist the base station to configure data transmission, wherein the UE information comprises at least one of the following: UE transmission status information, UE uplink QoS information, or UE application layer information.

### TECHNICAL FIELD

The present disclosure is directed generally to wireless communications. Particularly, the present disclosure relates to methods and devices for a user equipment (UE) transmitting UE information.

### BACKGROUND

A data transmission session in a communication network may include one or more data flows. A data flow within such a data transmission session may be associated with Quality of Service (QOS) information. The QoS information involve characteristics or requirements of data flow and provide the guarantee of communication service capability. Delivery of the QoS information may involve various network nodes, elements, or entities in the communication network and a multitude of signaling processes between these network nodes, elements, or entities.

The QoS information configured via traditional QoS mechanisms may be unable to dynamically match real-time service demand from one or more user equipments (UEs), leading to low efficiency and poor reliability.

### SUMMARY

This document relates to methods, systems, and devices for wireless communication, and more specifically, for transmitting, from a user equipment (UE), UE information. The various embodiments in the present disclosure may be beneficial to improve the efficiency of data transmission.

In one embodiment, the present disclosure describes a method for wireless communication. The method includes transmitting, by a user equipment (UE), UE information to a base station, wherein the UE information comprises at least one of the following: UE transmission status information, UE uplink (UL) quality of service (QOS) information, or UE application layer information.

In one embodiment, the present disclosure describes a method for wireless communication. The method includes receiving, by a base station, UE information from a user equipment (UE), the UE information configured to assist the base station to configure data transmission, wherein the UE information comprises at least one of the following: UE transmission status information, UE uplink quality of service (QOS) information, or UE application layer information.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system including one wireless network node and one or more user equipments.

FIG. 1B shows a schematic diagram of various embodiments in the present disclosure.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for a user equipment (UE) transmitting UE information.

In a communication network, an end-to-end communication may be established as a data communication session (alternatively referred to as a data session, or a communication session). Each data session may include transmission of data of different types, characteristics, and transmission requirements. As such, a data session may be configured as containing multiple data flows (which may be called QoS flow), with each data flow including data having similar transmission characteristics and/or associated with similar transmission quality requirements. Transmission of each of these data flows may be controlled and configured base on its transmission characteristics/requirements. For examples, allocation of communication resource to the data flow by the communication network may be based on the transmission characteristics/requirements of the data flow. Such transmission characteristics/requirements for the data flow may be used to determine a set of transmission parameters collectively referred to as QoS information for the data flow. The configuration of the transmission of the data flow (such as communication resource allocation) may then be based on such a QoS information. The determination and transmission of a QoS information may be performed by a network element in the communication network that is assigned for configuring and managing the transmission of the data flow. A “network element” may include one or more network nodes, one or more network functions, and/or one or more network entities.

A data flow may be associated with QoS information. In the network, QoS information is usually used to provide service guarantee. The QoS information involves characteristics or requirements of data flow. The QoS information may include the information of QoS parameter and QoS policy, such as QoS profile, QoS rule, and/or policy control and charging (PCC) rule.

In existing data transmission, a base station and/or a UE may passively perform data transmission based on the QoS information configuration determined by a core network, which may result in some issues/problems. For an example of the issues/problems, the UE information is unclear for the core network and/or the base station, so the QoS information may be inappropriate for data transmission of UE. According to the inappropriate QoS information, the base station may allocate the inappropriate resource to UE. Moreover, it is a too long process for changing QoS information configuration to match the time-varying network environment for data transmission. In the traditional QoS mechanism, the data transmission is inefficient.

The present disclosure describes various embodiments for a UE transmitting UE information and/or actively sending UE information, so that the network may configure more reasonable data transmission control information to improve data transmission efficiency.

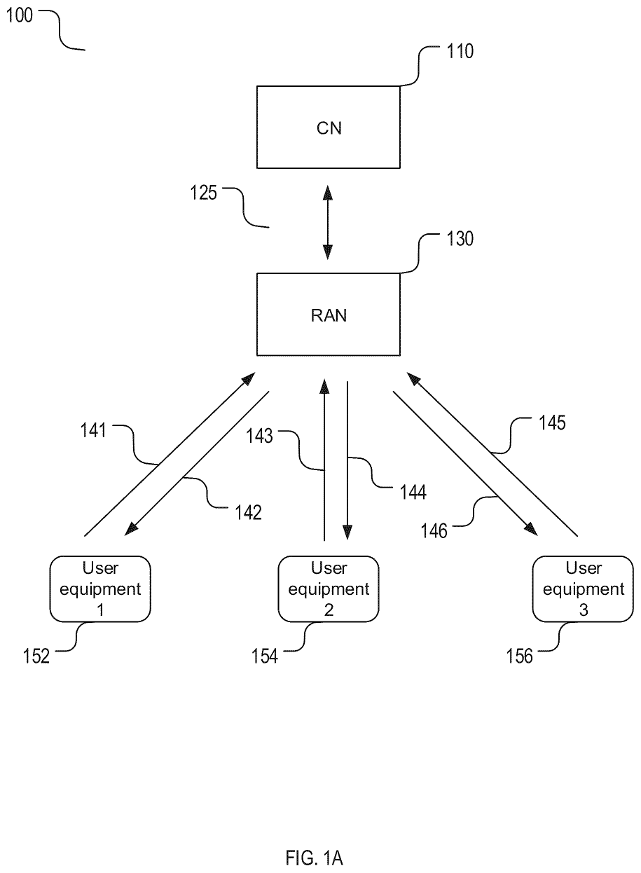

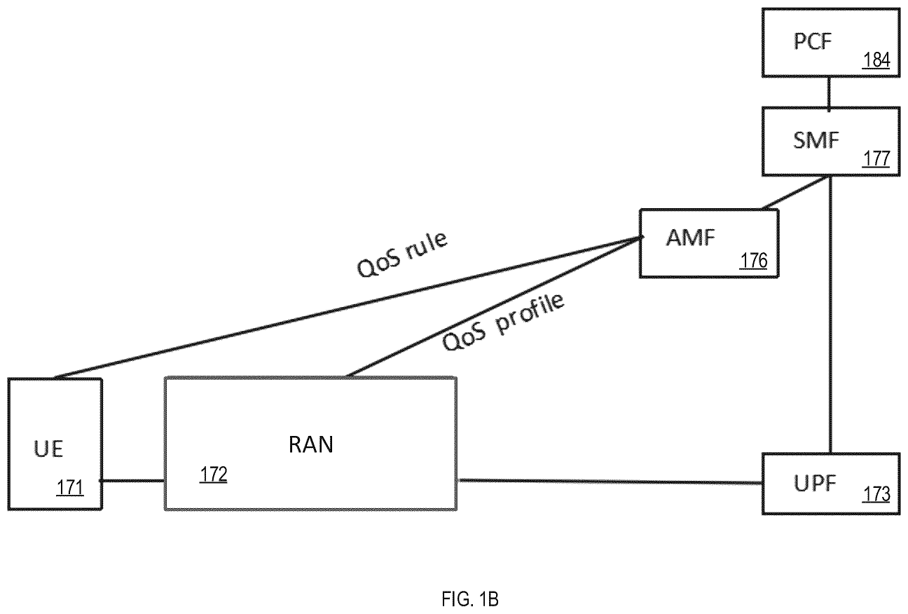

FIG. 1A shows a wireless communication system 100 including a core network (CN) 110, a radio access network (RAN) 130, and one or more user equipments (UEs) (152, 154, and 156). The RAN 130 may include one or more base stations. The base stations may include at least one evolved NodeB (eNB) for 4G Long Term Evolution (LTE), or a Next generation NodeB (gNB) for 5G New Radio (NR), or a NodeB for 6G, or any other type of signal transmitting/receiving device such as a UMTS NodeB. In one implementation, the core network 110 may include a 5G core network (5GC), and the interface 125 may include a new generation (NG) interface. The core network 110 further includes at least one policy control function (PCF), and/or at least one session management function (SMF), and/or at least one user plane function (UPF) and/or at least one access and mobility management Function (AMF).

Referring to FIG. 1A, a first UE 152 may receive one or more downlink communication 142 from the RAN 130 and send one or more uplink communication 141 to the RAN 130. Likewise, a second UE 154 may receive downlink communication 144 from the RAN 130 and send uplink communication 143 to the RAN 130; and a third UE 156 may receive downlink communication 146 from the RAN 130 and send uplink communication 145 to the RAN 130. For example but not limited to, a downlink communication may include a physical downlink (DL) shared channel (PDSCH) or a physical downlink control channel (PDCCH), and a uplink (UL) communication may include a physical uplink shared channel (PUSCH) or a physical uplink control channel (PUCCH).

In some implementations, the core network (CN) may include one or more core network functions related to the QoS information, as shown in FIG. 1B, which are described below. The core network may communicate with a UE 171 and/or communicate with the UE via the RAN 172.

Further description of the functionality of the various network nodes and network functions related to the QoS information in the wireless communication network of FIG. 1B are described in more detail.

Referring to UPF (User plane function) 173, the UPF performs the functionalities including but not limited to serving as an anchor point for intra-/inter-radio access technology (RAT) mobility, packet routing and forwarding, traffic usage reporting, quality of service (QOS) handling for the user plane, downlink packet buffering and downlink data notification triggering.

Referring to AMF (Access and Mobility Management function) 176, the AMF performs the functionalities including but not limited to registration management, connection management of, reachability management and mobility management of UE 171. AMF also performs access authentication and access authorization. The AMF 176 may have function as non-access stratum (NAS) security termination and relay the session management NAS messages between the UE 171 and SMF 177. The AMF 176 also performs SMF selection function during communication session establishment procedure and UE mobility procedure. The AMF may forward the QoS profile from the SMF to the RAN (or AN), and forwards the QoS rule from the SMF to the UE.

Referring to SMF (Session Management Function) 177, the SMF performs the functionalities including but not limited to establishment, modification, and release of communication sessions, UE IP address allocation and management (including optional authorization functions), selection and control of UPF 173, and downlink data notification. Each SMF may control one or more UPFs and is associated with a service area being a collection of UPF service areas of all UPFs under its control. The SMF derives the QoS profile according to the PCC rule, generates a QoS flow, sends the QoS profile to the RAN, and sends the packet detection rule (PDR) to the UPF. The PCC rule is bound to the QoS flow. In some implementations, the SMF also selects the UPF based on the granularity of the UE or session, and can assign IP addresses, collect charging data, connect to the charging center, and so on.

Referring to PCF (Policy Control Function) 184, the PCF is responsible for a unified policy framework, provides policy rules for control plane functions, determines policy control and charging (PCC) rules, and authorizes a session management function (SMF) on service data flow (SDF) basis. The PCF performs the functionalities including but not limited providing policy rules and controlling other network nodes to enforce the policy rules. Specifically, the PCF provides access and mobility related policies to the AMF 176 so that the AMF 176 enforces them during mobility procedure.

In some implementations in 5G NG, a QOS flow is associated with QoS requirements as specified by one or more QoS parameters and QoS characteristics in QoS information. Any QoS flow may be characterized by: a QoS profile provided by the SMF to the AN via the AMF over the N2 reference point or preconfigured in the AN; one or more QoS rule(s) and optionally QoS flow level QoS parameters associated with these QoS rule(s) which can be provided by the SMF to the UE via the AMF over the N1 reference point and/or derived by the UE by applying reflective QoS control; and/or one or more UL and DL PDR(s) provided by the SMF to the UPF. For each QoS flow, the QoS profile may comprise the QoS parameters, for example, 5G QOS identifier (5QI), and/or allocation and retention priority (ARP). For each non-GBR QoS flow only, the QoS profile may also comprise the QoS parameter, for example, reflective QoS attribute (RQA). For each GBR QoS flow only, the QoS profile may also comprise the QoS parameters, for example, guaranteed flow bit rate (GFBR), and/or maximum flow bit rate (MFBR); In the case of a GBR QoS flow only, the QoS profile may also comprise one or more of the QoS parameters, for example, notification control, maximum packet loss rate. In 5G NR, the 5G QOS characteristics as the part of QoS profile associated with 5QI may comprise at least one of the following: resource type (e.g., GBR, delay critical GBR, or non-GBR), priority level, packet delay budget (including core network packet delay budget), packet error rate, averaging window (for GBR and/or delay-critical GBR resource type only), and/or maximum data burst volume (for delay-critical GBR resource type only).

In some implementations in 5G NG, the PCF determines QoS policy such as PCC rules according to the obtained service requirements and subscription information, and the PCC rules comprise QoS parameters and charging policies. The SMF performs the binding of SDFs to QoS Flows based on the QoS and service requirements. After receiving the PCC rules provided by the PCF, the SMF assigns the QFI for a new QoS flow and derives its QoS profile, corresponding UPF instructions and QoS rule(s) from the PCC rules and other information provided by the PCF. When a PDU session is established, the SMF transmits QoS information by configuring PDR for UPF, QOS profile for RAN, and QoS rule for UE. According to the QoS information from the SMF, the UPF maps the IP data flow into multiple QoS flows by means of a PDU session. The SMF provides the QoS profile to the access network via the AMF, thereby instructing the access network (AN) to perform data flow matching and mapping of radio bearers. The uplink transmission of the UE matches and maps the data packets according to the QoS rules, and the QoS rules are also sent to the UE by the SMF via the AMF in the NAS message. For the QoS flow of GBR, alternative QoS profiles can also be transmitted by enabling notification control, and the access network can select a set of appropriate QoS parameters from multiple sets of QoS profiles. The QoS profile may be used for long time in the PDU session until the RAN selects the alternative QoS profile and feedbacks it to CN. The QoS information transmission via the control plane is in semi-static mode. But the UE information such as UE transmission status information, UE uplink quality of service (QOS) information, or UE application layer information is not comprised in the QoS information. The QoS information is inaccurate and inappropriate for data transmission because the network cannot know the situation of UE in time. The core network may not determine the appropriate QoS rule for UE. The base station can not allocate the appropriate resource and schedule efficiently for UE traffic. The resource comprises but not limit as following: bearer, channel, resource of time domain, resource of frequency domain, resource of spatial domain and so on. The bearer may be radio bearer, such as data radio bearer (DRB), signalling radio bearer (SRB). The channel may be logical channel (LC), logical channel group (LCG), transport channel, or physical channel.

The present disclosure describes various embodiments for a UE transmitting UE information and/or actively sending the UE information, addressing at least one of the issues/problems discussed above, so that the network may configures more reasonable data transmission control information to improve data transmission efficiency according to the UE information.

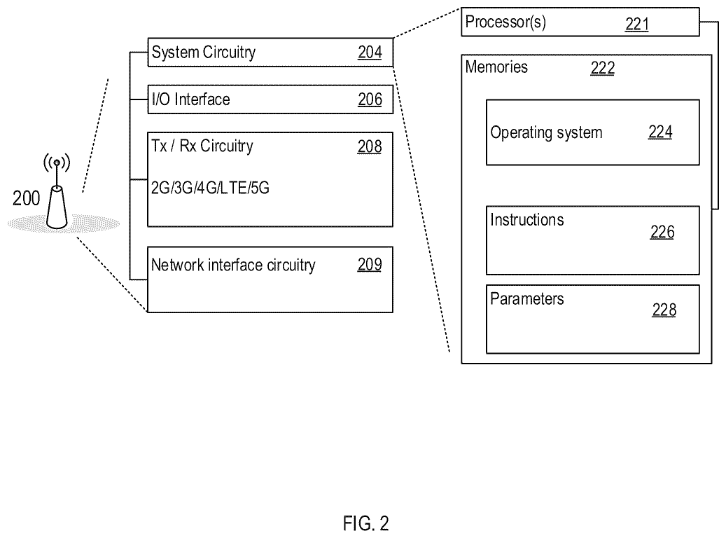

FIG. 2 shows an example of electronic device 200 to implement one or more core network functions or one or more base stations. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

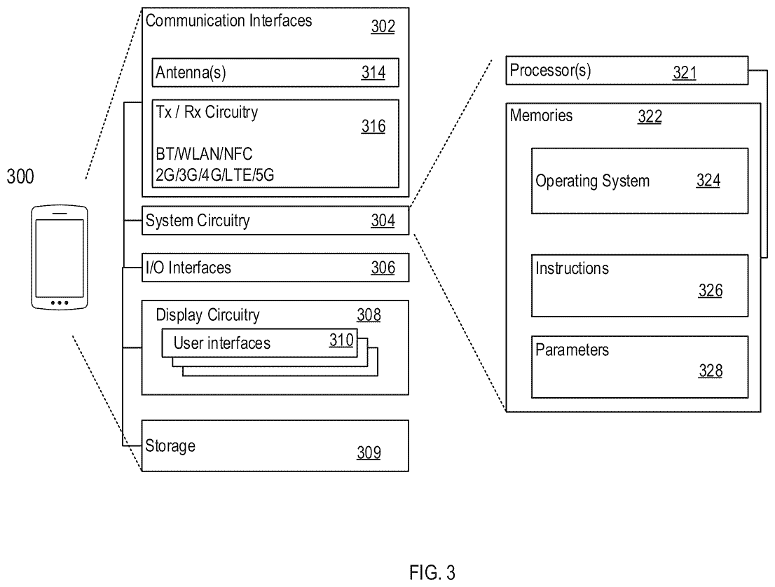

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for a user equipment (UE) transmitting the UE information, which may be implemented, partly or totally, on the core network function, the access network, and/or the user equipment described above in FIGS. 2-3.

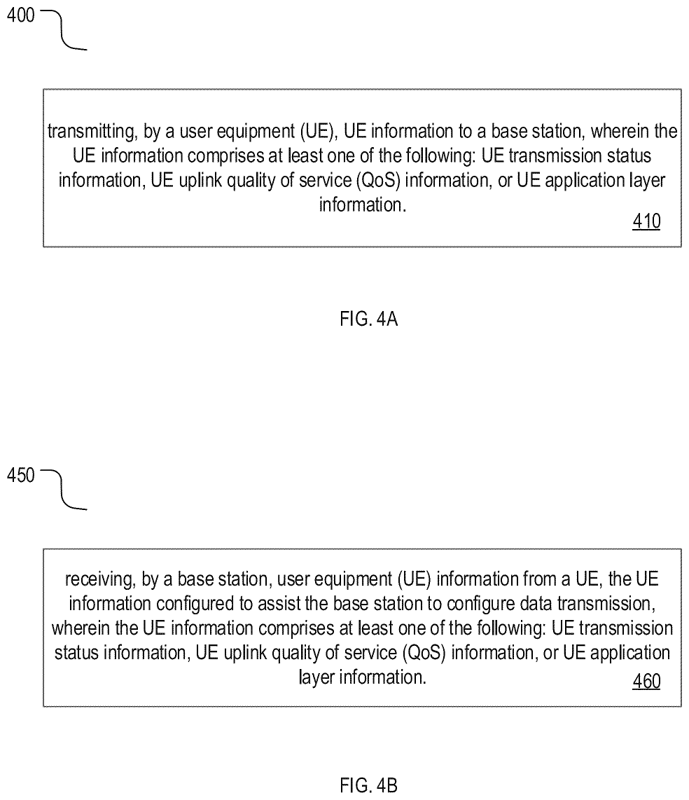

Referring to FIG. 4A, the present disclosure describes various embodiments of a method 400 for wireless communication. The method may include step 410: transmitting, by a user equipment (UE), UE information to a base station, wherein the UE information comprises at least one of the following: UE transmission status information, UE uplink quality of service (QOS) information, or UE application layer information.

Referring to FIG. 4B, the present disclosure describes various embodiments of a method 450 for wireless communication. The method may include step 460: receiving, by a base station, UE information from a user equipment (UE), the UE information configured to assist the base station to configure data transmission, wherein the UE information comprises at least one of the following: UE transmission status information, UE uplink quality of service (QOS) information, or UE application layer information.

In some implementations, which may combine a portion or all of the other implementation(s) described in the present disclosure, the method 400 may further include receiving, by the UE, data transmission control information, wherein the data transmission control information is configured by the base station according to the UE information.

In some implementations, which may combine a portion or all of the other implementation(s) described in the present disclosure, the method 400 may further include receiving, by the UE, an enable signaling from the base station, wherein the enable signaling is used to enable the UE to transmit the UE information.

In some implementations, which may combine a portion or all of the other implementation(s) described in the present disclosure, the transmitting, by the UE, the UE information to the base station comprises at least one of the following: transmitting, by the UE, to the base station via uplink control information (UCI); transmitting, by the UE, to the base station via medium access control (MAC) control element (CE); transmitting, by the UE, to the base station via radio resource control (RRC) message; and/or transmitting, by the UE, non-access stratum (NAS) message carrying the UE information to a core network for the base station that obtains the UE information from the core network.

In some implementations, which may combine a portion or all of the other implementation(s) described in the present disclosure, the UE transmission status information comprises at least one of the following: downlink (DL) traffic receiving status, a block error rate (BLER) of downlink data, a clock synchronization error, a packet loss rate of downlink data, a first transmission success rate of downlink data, a retransmission probability, a maximum number of retransmissions, a number of retransmissions of downlink data, or a duration of no PDCCH.

In some implementations, which may combine a portion or all of the other implementation(s) described in the present disclosure, the UE application layer information comprises at least one of the following: an indicator for indicating whether an application layer service is interrupted, an indicator for indicating application layer service continuity, an application layer packet arrival prediction information, an application layer packet delay indicator, an indicator for indicating application layer service availability, an indicator for indicating application layer service status, application layer status information, application layer requirements for network layer, or application layer QoS request for network layer.

In some implementations, which may combine a portion or all of the other implementation(s) described in the present disclosure, the UE uplink quality of service (QOS) information comprises at least one of the following: a specific traffic identifier (ID), a specific service identifier (ID), the downlink traffic identifier (ID) associated with uplink traffic, the downlink service identifier (ID) associated with uplink service, the downlink logical channel ID associated with uplink traffic, the downlink packet ID associated with uplink traffic, a packet size, a traffic period, a traffic arrival time, a bit error rate (BER), a transport block (TB) size, a packet delay budget (PDB), a QoS identifier, a QoS profile, a QoS rule, a QoS parameter index, a QoS parameter set index, a QoS parameter value, a QoS parameter range, a QoS parameter set corresponding to a specific traffic, a maximum TB size, a processing delay of UE, a transmission delay of UE, a power head of UE, a UE battery consumption parameter, UE hardware resource information, and/or a computing power information.

In some implementations, which may combine a portion or all of the other implementation(s) described in the present disclosure, the UE uplink quality of service (QOS) information comprises at least one of the following: communication capability information of UE, expected QoS information, a QoS parameter that UE is capable of supporting, a deterministic level that UE is capable of providing, a deterministic capability that UE is capable of providing, QoS information of a specific traffic, and/or QoS information of a specific service.

In some implementations, which may combine a portion or all of the other implementation(s) described in the present disclosure, the UE obtains the UE application layer information by at least one of the following: the UE obtains the UE application layer information from a header field of a data packet in which the UE application layer information is carried; the UE obtains the UE application layer information from a data field of a data packet in which the UE application layer information is carried; the UE obtains the UE application layer information in a NAS message from a core network; the UE obtains the UE application layer information through the application layer on the UE side, wherein the application layer delivers the application layer information to a NAS layer on the UE side; the UE obtains the UE application layer information by the interface between the application layer and radio communication network; the UE obtains the UE application layer information by the tunnel between the application layer and radio communication network; the UE obtains the UE application layer information through the specific application layer packet from the application layer, wherein the specific application layer packet carries the application layer information; or the UE obtains the UE application layer information through the specific application layer packet from the application layer, wherein the specific application layer packet comprises at least one of the following: application layer status information, application layer requirements for network layer, or application layer QoS request for network layer.

In some implementations, which may combine a portion or all of the other implementation(s) described in the present disclosure, the UE information comprises the UE uplink quality of service (QOS) information; and/or the UE uplink quality of service (QoS) information is corresponding to transmission resource of the UE determined by the base station, and the UE transmits data in response to the uplink QoS information on the transmission resource.

In some implementations, which may combine a portion or all of the other implementation(s) described in the present disclosure, the UE information corresponding to the transmission resource comprises at least one of the following: a UL grant corresponding to a specific traffic identifier, wherein the specific traffic identifier is associated with a specific traffic identifier in the UE information, and the specific traffic data in response to the specific traffic identifier is transmitted on the transmission resource indicated by the UL grant with the specific traffic identifier; a specific traffic identifier that is associated with a logical channel priority allocated by the base station, and the specific traffic data in response to the specific traffic identifier is transmitted according to the logical channel priority; a specific traffic identifier that is associated with a logical channel (LC), and the specific traffic data in response to the specific traffic identifier is transmitted on the logical channel; a specific traffic identifier that is associated with a logical channel group (LCG), and the specific traffic data in response to the specific traffic identifier is transmitted on the logical channel group; a specific traffic identifier that is corresponding to a specific radio bearer, and the specific traffic data in response to the specific traffic identifier is transmitted on the specific radio bearer; a specific traffic identifier that is corresponding to one or more Hybrid Automatic Repeat reQuest (HARQ) process IDs, and the specific traffic data in response to the specific traffic identifier is transmitted on resource in response to the one or more HARQ process IDs; and/or a specific traffic identifier that is corresponding to a slot set, and the specific traffic data in response to the specific traffic identifier is transmitted on resource in response to the slot set.

In some implementations, which may combine a portion or all of the other implementation(s) described in the present disclosure, the UE transmitting the UE information comprises at least one of the following: transmitting, by the UE, the UE information in response to receiving a trigger signaling from the base station, wherein the trigger signaling is used to trigger the UE to transmit the UE information; periodically transmitting, by the UE, the UE information to the base station according to periodic information, wherein the periodic information is configured by the base station; transmitting, by the UE, the UE information to the base station according to a message from an upper layer of the UE; and/or transmitting, by the UE, the UE information to the base station in response to one or more trigger conditions being met.

In some implementations, which may combine a portion or all of the other implementation(s) described in the present disclosure, the one or more trigger conditions comprises at least one of the following: whether the UE transmission status information is above a threshold; whether the UE transmission status information is below a threshold; whether a radio link is failure; whether a downlink measurement is below a threshold; whether a new session is established; whether a new data tunnel of the UE is established; whether a UE state is switched from an idle state to an active state; whether a UE state is switched from an inactive state to an active state; whether the UE is power-on from a power-off state; whether a UE state is switched from a dormant state to a wake-up state; whether a new traffic is initiated for the UE; whether a service of the UE is interrupted; whether the UE is access to a network; whether a UE capability is updated; whether the UE receives an indicator for indicating a transmission of the UE information; and/or whether a UE transmission state is from a no-data-transmission state to a data-transmission state.

In some implementations, which may combine a portion or all of the other implementation(s) described in the present disclosure, the data transmission control information comprises at least one of the following: a QoS profile, a QoS rule, a QoS parameter index, a QoS parameter set index, a QoS parameter value, a QoS parameter range, a specific traffic identifier, a QoS parameter set indicator corresponding to a specific traffic, a QoS classification indicator, a logic channel priority, a logic channel ID, a logic channel group ID, a time-frequency domain resource, a number of resource elements (REs), a modulation coding scheme (MCS), a transport block size (TB size), spatial multiplexing information, power information, a specific traffic ID, a radio bearer ID, and/or schedule information.

In some implementations, which may combine a portion or all of the other implementation(s) described in the present disclosure, the UE information is transmitted in a manner comprising at least one of the following: transmitting based on a period, transmitting based on an event trigger, transmitting based on a time trigger, transmitting based on a timer, transmitting as a control signaling, transmitting as a data packet, or transmitting as a measurement report message.

In some implementations, which may combine a portion or all of the other implementation(s) described in the present disclosure, the method 400 may further include, after receiving data transmission control information configured and transmitted by the base station, performing, by the UE, at least one of the following: taking the data transmission control information from the base station as the QoS information for the UE; mapping a specific traffic to a specific radio bearer; mapping a specific traffic to a specific logical channel; mapping a specific traffic to a specific logical channel group; mapping a specific traffic to one or more logical channels with a priority from the data transmission configuring information; selecting a set of QoS parameters; configuring one or more QoS parameters for the UE; mapping a specific traffic to a resource indicated by a UL grant in response to a specific traffic identifier; mapping a specific traffic to a resource of one or more HARQ IDs in response to a specific traffic identifier; and/or mapping a specific traffic to a resource of a slot set in response to a specific traffic identifier.

In some implementations, which may combine a portion or all of the other implementation(s) described in the present disclosure, the method 400 may further include obtaining, by the UE, the UE information by at least one of the following: obtaining the UE information by measurement; obtaining the UE information by awareness; obtaining the UE information by historical data statistics; obtaining the UE information by AI training and predication; and/or obtaining the UE information by information transmitted via an application layer.

In some implementations, which may combine a portion or all of the other implementation(s) described in the present disclosure, the method 400 may further include, before transmitting the UE information, performing, by the UE, at least one of the following: transmitting, by the UE, to the base station, a request for transmitting the UE information; receiving, by the UE, from the base station, a response for indicating the UE to transmit the UE information, wherein the response comprises the resources allocated for the UE information transmission; and/or transmitting, by the UE, to the base station, the UE information on the resources indicated in the response.

In some implementations, which may combine a portion or all of the other implementation(s) described in the present disclosure, the method 450 may further include configuring, by the base station, data transmission control information for the UE according to the UE information; and/or transmitting, by the base station, the data transmission control information according to the UE information.

In some implementations, which may combine a portion or all of the other implementation(s) described in the present disclosure, the receiving, by the base station, the UE information from the UE comprises: receiving, by the base station, the UE information from a core network, wherein the core network receives non-access stratum (NAS) signaling from the UE, the NAS signaling comprising the UE information, and the core network configured to transmit the UE information to the base station.

In some implementations, which may combine a portion or all of the other implementation(s) described in the present disclosure, the method 450 may further include: receiving, by the base station, a request for transmitting the UE information from the UE; and/or allocating, by the base station, the resources for the UE information transmission; and/or transmitting, by the base station, a response for indicating the UE to transmit the UE information, wherein the response comprises the resources allocated for the UE information transmission; and/or receiving, by the base station, the UE information on the resource indicated in the response.

The present disclosure describes below a plurality of various non-limiting embodiments and/or examples for a user equipment (UE) transmitting the UE information. These embodiments and/or samples are described as some of many possible implementations of the present disclosure, and do not impose any limitations on the present disclosure.

### Embodiment 1

The present disclosure describes some embodiments for a UE actively transmitting UE information to a base station. The embodiment may include a portion or all of the following steps.

In step 11, before new data transmission, the UE sends the UE information such as UL QOS information, UE application layer information. The UE information may be carried in NAS message to the core network. The new data transmission comprises, but is not limited to, the establishment of a new session, the new data transmission after DTX, and the establishment of a data connection with the core network. The UL QOS information implies UL QOS requirement and may be expressed as one or more UL QOS profiles. UE application layer information reflects the application layer requirement such as service continuity, application layer packet arrival prediction information, application layer service status.

In step 12: The core network receives the UE information from the UE. For example, an AMF receives the UE information via a NAS message. Then a PCF and a SMF may obtain the UE information from the AMF.

In step 13: The core network sends the UE information to the base station. Furthermore, the core network sends the UE information to the base station after the core network modifies the UE information. For example, the SMF determines and/or selects one or more QoS profiles as the UE information to the base station according to the UE information received from the UE. Further, the core network update the QoS rules for UE according to the UE information received from the UE. For example, the PCF modifies the QoS rules and SMF send them to the UE through AMF, therefore the UE may use the updated QoS rules for the data transmission.

In step 14: The base station receives the UE information. The base station receives the UE information from the core network, for example, from SMF.

In step 15: The base station allocates the resource for the UE data transmission according to the UE information received from the CN. That the base station allocates the resource comprises but is not limited to: the base station schedules the UE; the high layer of the base station maps one or more DRBs to UE; the base station allocates one or more logic channels to UE; the base station allocates one or more logic channel groups to UE; the base station allocates the transport resource to UE; the base station allocates the specific time-frequency domain resource to UE; or the base station allocates the specific spatial resource to UE.

In step 16: The base station determines and configures the data transmission control information for UE data transmission. The data transmission control information comprises at least one of the following: a logic channel priority, a logic channel ID, a logic channel group ID, a time-frequency domain resource, a number of resource elements (REs), a modulation coding scheme (MCS), a transport block size (TB size), spatial multiplexing information, power information, a specific traffic ID, a radio bearer ID, or schedule information.

In step 17: The base station sends the data transmission control information to the UE for indicating the UE data transmission.

In step 18: The UE receives the data transmission control information and transmits the data according to the data transmission control information. That the UE transmits the data comprises but is not limited to: the UE transmits the traffic data in the resource indicated by the data transmission control information; the UE transmits the traffic data by the schedule information indicated by the data transmission control information, for example, the schedule information may be MCS, resource position or spatial multiplexing information; or the UE transmits the traffic data not larger than the TB size indicated by the data transmission control information. Further, the UE maps and transmits the traffic data according to the data transmission control information from the base station and the QoS rules from the core network.

In some implementations, the UE may transmit the UE information directly to the base station without the core network forwarding process. Therefore, the step 12 and step 13 above may be cancelled.

In some implementations, the base station transmits an enable signal of sending actively the UE information to UE firstly. The enable signal indicates that the UE is activated to actively send UE information. The enable signal may be carried in a medium access control layer (MAC) control element (CE), a downlink control information (DCI) message or a radio resource control (RRC) message. The UE may send the UE information in an trigger condition after it receives the enable signal,

In some implementations, the UE information comprises UE transmission status information. When the UE information is transmitted to the core network, the core network may know the UE transmission effect (e.g., delay, jitter, packet loss, or etc.) and select the appropriate QoS parameter to match the UE transmission. When the UE information is transmitted to the base station, the base station may know the UE downlink transmission performance/situation and allocates the appropriate transmission resource(s) and data transmission control information. For a non-limiting example, the UE information comprises any one or any combinations of the following (but is not limited to): a downlink (DL) bit error rate (BER), a downlink (DL) block error rate (BLER), radio link condition, or etc.), downlink (DL) traffic receiving status, a clock synchronization error, a packet loss rate of downlink data, a first transmission success rate of downlink data, a retransmission rate of downlink data, a maximum number of retransmissions of downlink data, a number of retransmissions of downlink data, or a duration of no PDCCH. The base station knows the DL traffic transmission according to the UE information. Then the base station determines how to transmit the UL traffic of UE referring to the DL traffic transmission of UE. The base station also determines the data transmission control information for UL traffic of UE referring to the DL traffic transmission of UE.

In some implementations, after receiving the UE information, the base station actively sends the processing capability to the core network for the appropriate QoS parameter and/or QoS policy. For one non-limiting example, in a Time sensitive network (TSN) scenario, the base station find the UE traffic requirement beyond the capacity of the base station after receiving the UE information, it may actively send one or the base station information that the base station can support to ensure that the deterministic requirements for the base station are met within a reasonable range. The TSN may adjust the policy, such as node re-orchestrating, the deterministic requirements revision for the base station. The base station information comprises but is not limited to: the deterministic capability that the base station can support, the deterministic level of the base station, the traffic packet size that the base station can support, the service delay that the base station can support, the traffic jitter range that the base station can support, and/or service reliability that the base station can support. Because the QoS information to the base station is considered whether the base station can support the service requirements and the deterministic requirements, it avoids the uncertainty risk caused by exceeding the capacity of the base station.

### Embodiment 2

The present disclosure describes some other embodiments for a UE actively transmitting the UE information such as the uplink QoS requirements and/or UE transmission status information to a base station, and the base station adjusting a scheduling policy according to the UE information. The embodiment may include a portion or all of the following steps.

In step 21: The UE obtains the UE information. The UE information is obtained in one of the following ways: UE obtains through measurement; UE obtains through perception; UE obtains historical data statistics; UE obtains from the artificial intelligence (AI) network element, and/or the UE obtains through information transmitted by the upper layer (e.g., application layer). The UE information may be used for either uplink or downlink data communication (or both).

In step 22: The UE actively transmits the UE information to the base station. The UE information comprises but is not limited to: the priority information for uplink traffic, the jitter range for uplink traffic, the reliability requirement information for uplink traffic, the relationship information between uplink traffic packets, the relationship information between downlink traffic packets and uplink traffic packets, or the packet loss tolerance information for uplink traffic.

In step 23: The base station receives the UE information actively sent by the UE, and determines a scheduling policy. For a non-limiting example, if the base station knows through the UE information that the traffic is required in low packet loss tolerance, it may prioritize the UE and allocate the best time-frequency resources with smart scheduling (or intelligent scheduling). The intelligent scheduling method comprises pre-configured scheduling data volume and pre-scheduling duration.

### Embodiment 3

The present disclosure describes various ways (or methods) for a UE to transmit the UE information. The embodiment may include a portion or all of the following.

In some implementations, the UE information may be transmitted to the base station through uplink control information (UCI). Furthermore, the UE information may be indicated in scheduling request (SR), or channel state information (CSI) of UCI. The UCI may be carried on physical uplink control channel (PUCCH) or PUSCH.

In some implementations, the UE information may be transmitted to the base station through a medium access control layer (MAC) control element (CE). Further, the UE information may be indicated in buffer status reporting (BSR). The BSR may be carried on PUSCH.

In some implementations, the UE information may be transmitted to the base station through a radio resource control (RRC) message. Further, the UE information may be indicated in RRC message.

In some implementations, the UE information may be transmitted to the base station via the control plane or the user plane. When via the control plane, the UE information is transmitted in signalling message. For example, the UE information is carried in RRC message, NAS message or application layer message. When via the user plane, the UE information is transmitted as traffic data flow. For example, there is the specific packet type for the UE information if the UE information is transmitted in the way of packet. Further, the UE information as an application packet.

In some implementations, the UE transmitting the UE information to the base station may be that the UE transmits the UE information to the base station through the core network. For example, the UE sends the UE information to the core network through a NAS message and the UE information is carried in NAS message, and the core network then sends the UE information to the base station.

In some implementations, the UE transmitting the UE information to the core network may be that the UE application layer transmits the UE information to the UE NAS layer and UE transmits the UE information to the core network by NAS message in NAS layer.

### Embodiment 4

The present disclosure describes various components in the UE information associated with a specific traffic. For the specific traffic, special QoS guarantees may be needed. By actively sending the UE information related to the specific traffic requirements, it may help the network to improve the specific traffic experience. Several non-limiting examples are described below for illustration only.

For one non-limiting example, UE is aware of a specific uplink (UL) traffic requirement such as UL application requirement and transmits the UE information to the base station. The UE information comprises a specific traffic ID and the traffic requirement. The base station determines how to transmit the specific traffic of UE and allocates logical or physical resource(s) for UE. Moreover, the base station transmits the data transmission control information of indicating the UE to transmit the specific traffic in uplink. The specific traffic ID and allocated resource(s) for the specific traffic are comprised in the data transmission control information. The data transmission control information may be carried in the UL grant. After the UE receives the data transmission control information, it transmits the specific traffic data on the allocated resource(s). For example, the base station allocated the specific resource in advance for the forthcoming time sensitive traffic of UE according to the traffic ID and the traffic requirement in the UE information. The UE transmits the time sensitive traffic on the specific resource according to the time sensitive traffic ID and the specific resource indicated in the UL grant. The traffic requirement including but is not limited to: deterministic traffic level, deterministic traffic packet size, deterministic traffic delay, deterministic traffic jitter range, deterministic traffic reliability, deterministic traffic period, expected arrival time, and/or required Bit Error (BER). The specific resource including but is not limited to: the data radio bearer ID associated with the traffic ID, the logic channel ID associated with the traffic ID, the logic channel group ID associated with the traffic ID, the HARQ process ID associated with the traffic ID, and/or the resource indicator in time-frequency domain associated with the traffic ID.

In some implementations, the UE information is UE uplink quality of service (QoS) information. The UE uplink quality of service (QOS) information comprises at least one of the following: the downlink traffic identifier (ID) associated with uplink traffic, the downlink service identifier (ID) associated with uplink service, the downlink logical channel ID associated with uplink traffic, or the downlink packet ID associated with uplink traffic. Because the base station knows the relationship between the uplink traffic and downlink traffic according to the UE information, the UE may transmit the uplink traffic referring to the transmission mode of downlink traffic. For example, the UE transmits the UE information of downlink traffic identifier (ID) associated with uplink traffic. The base station may allocate the same resource of the downlink traffic to the uplink traffic.

In some implementations, the UE is aware of a specific uplink (UL) traffic requirement such as UL application requirement and transmits the UE information associated with the specific traffic ID to the core network. The core network configures one or more QoS profile to the specific traffic and transmits the QoS profile(s) with the specific traffic ID to the base station. The base station allocated the specific resource for the specific traffic of UE according to the QoS profile(s) and the specific traffic ID. The UE transmits the specific traffic data in the specific resource under the base station specific control.

In some implementations, the UE information comprises any one or any combinations of the following (but is not limited to): traffic type, traffic characteristics, traffic arrival time. For example, in an extended reality (XR) scenario, there are three frame type with different importance. The frame may be the most important and may require higher QoS guarantee. The UE sends the UE information which comprises the uplink frame arrival time of every frame type to the core network in advance. The core network may assign different QoS parameters to different frame types. The base station may allocate different uplink resources to the UE for different frame types.

In some implementations, the UE may associate the UE information such as the uplink TB Size, PDB, BER with the specific traffic to help the core network determine QoS policies and parameters for the specific traffic. In some implementations, the UE information comprises UE uplink quality of service (QOS) information associated with the specific traffic ID. The UE uplink quality of service (QOS) information comprises the expected UL QoS profile of the specific traffic and the specific traffic ID.

In some implementations, the base station may allocate the resource for UL specific traffic according to the UE information. The UE information comprises any one or any combinations of the following (but is not limited to): the expected uplink TB Size, the maximal uplink TB Size, the expected uplink slot, the expected uplink duration, the expected uplink period and/or the expected uplink carrier frequency.

In some implementations, UE information comprises any one or any combinations of the following (but is not limited to): application layer service requirements, application layer service status, application layer traffic requirements, application layer traffic status, traffic type, traffic characteristics, application layer status information, application layer requirements for network layer, or application layer QoS request for network layer. The application layer service status comprises the following (but is not limited to): service continuity, service interrupted, or service availability. The application layer traffic status comprises the following (but is not limited to): an application layer packet arrival prediction information, an application layer packet delay indicator.

### Embodiment 5

The present disclosure describes embodiments for a UE to determine the UE information.

In some implementations, the UE determines the UE information through measurement. For example, the UE obtain the radio link quality of the UE information by measurement. The measurement comprises any one or any combinations of the following (but is not limited to), channel state information (CSI) measurement, radio resource management (RRM) measurement, radio link failure (RLF) measurement, and/or service status measurement.

In some implementations, the UE determines the UE information through perception. According to the historical data statistics, the UE derives the UE information such as the suggested QoS profile, the suggested resource.

In some implementations, the UE obtains the UE information through an artificial intelligence (AI) network element. The AI network element may analyze the historical data and create the UE information. For example, the AI network element may suggest one set of QoS parameter in the UE information. The AI network element may be a node, a function, or an entity.

In some implementations, the UE determines the UE information through transmitted by the upper layer (e.g., application layer). The application layer on UE side delivers the application layer information to the UE lower layer such as NAS layer, radio resource control (RRC) layer, packet data convergence protocol (PDCP) layer. In some implementations, the UE information is carried in a message. In some implementations, the UE information is carried in the header of data PDU.

In some implementations, the UE obtains the UE application layer information by UE application layer delivering the application layer information to a NAS layer on the UE side. For example, the UE application layer information may be delivered through the interface between the application layer and radio communication network. For another example, the UE application layer information may be delivered through the tunnel between the application layer and radio communication network. In some implementations, the UE application layer information may be carried by the way of the specific application layer packet from the application layer. The specific application layer packet comprises at least one of the following: application layer status information, application layer requirements for network layer, or application layer QoS request for network layer. In some implementations, after the NAS layer of the UE obtains the UE application layer information from application layer, the UE transmits the UE application layer information to the core network by NAS message. And the core network transmits the UE information containing the UE application layer information to the base station. In some implementations, the UE application layer information may be carried in the header field of the application layer packet from the application layer. In some implementations, the UE application layer information may be carried in the data field of the application layer packet from the application layer.

In some implementations, the UE determines the UE information according to reception of downlink data. From the analysis of downlink data information, the UE derived the UE information. For example, the UE may analyze the downlink data configuration parameter and downlink data error. By the analysis, the UE find the high error rate for downlink data in the specific resource with a specific HARQ process ID. Then the UE suggests the resource with another HARQ process ID in the UE information.

### Embodiment 6

The present disclosure describes various ways (or methods) of triggering a transmission of the UE information. The triggering manner for a UE to send the QoS information may be time-based triggering or event-based triggering. Time-based triggering method include at least one of the following: period-based transmission, timer-based transmission, and the like. The event-based triggering method includes at least one of the following: sending when the UE accesses the network for the first time, sending when the capability of the UE is updated, and the like.

In some implementations, one way for the UE to trigger the reporting of the UE information is: after the UE accesses the network for data transmission for a period of time, the UE may obtain the data information from the base station, and the UE locally stores the historical data information. When the UE initiates a new traffic, the UE compares the difference between the current traffic data requirement and the historical data information. When the UE finds it can not meet the traffic requirement based the historical data information, the UE is triggered to transmit the UE information.

In some implementations, another way for the UE to trigger the reporting of UE information is: the UE first initiates a request of transmitting the UE information, and the base station indicates UE how to transmit the UE information and allocates transmission resources for the UE in the response message. Then the UE transmits the UE information in the resources indicated in the response message.

In some implementations, another method for the base station to trigger the reporting of UE information is as follows: the base station may transmit a signaling message to trigger the UE report the UE information. For example, a signaling message is an enable signaling to enable the UE information. For another example, a signaling message is a measurement message and the measurement message indicate the UE to transmit the UE information.

The present disclosure describes methods, apparatus, and computer-readable medium for wireless communication. The present disclosure addressed the issues with a user equipment (UE) transmitting UE information. The methods, devices, and computer-readable medium described in the present disclosure may facilitate the performance of wireless communication by a UE transmitting UE information, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
transmitting, by a user equipment (UE), UE information to a base station, wherein the UE information comprises at least one of the following: UE transmission status information, UE uplink quality of service (QOS) information, or UE application layer information.

2. The method according to claim 1, further comprising:
receiving, by the UE, data transmission control information, wherein the data transmission control information is configured by the base station according to the UE information.

3. The method according to claim 1, further comprising:
receiving, by the UE, an enable signaling from the base station, wherein the enable signaling is used to enable the UE to transmit the UE information.

4. The method according to claim 1, wherein the transmitting, by the UE, the UE information to the base station comprises at least one of the following:
transmitting, by the UE, to the base station via uplink control information (UCI);
transmitting, by the UE, to the base station via medium access control (MAC) control element (CE);
transmitting, by the UE, to the base station via RRC message; or
transmitting, by the UE, non-access stratum (NAS) message carrying the UE information to a core network for the base station that obtains the UE information from the core network.

5. The method according to claim 1, wherein:
the UE transmission status information comprises at least one of the following: downlink (DL) traffic receiving status, a block error rate (BLER) of downlink data, a clock synchronization error, a packet loss rate of downlink data, a first transmission success rate of downlink data, a retransmission rate of downlink data, a maximum number of retransmissions of downlink data, a number of retransmissions of downlink data, or a duration of no PDCCH.

6. The method according to claim 1, wherein:
the UE application layer information comprises at least one of the following: an indicator for indicating whether an application layer service is interrupted, an indicator for indicating application layer service continuity, an application layer packet arrival prediction information, an application layer packet delay indicator, an indicator for indicating application layer service availability, an indicator for indicating application layer service status, an indicator for indicating whether an application layer traffic is interrupted, an indicator for indicating application layer traffic continuity, an indicator for indicating application layer traffic availability, an indicator for indicating application layer traffic status, application layer status information, application layer requirements for network layer, or application layer QoS request for network layer.

7. The method according to claim 1, wherein:
the UE uplink quality of service (QOS) information comprises at least one of the following: a specific traffic identifier (ID), a specific service ID, the downlink traffic ID associated with uplink traffic, the downlink service ID associated with uplink service, the downlink logical channel ID associated with uplink traffic, the downlink packet ID associated with uplink traffic, a packet size, a traffic period, a traffic arrival time, a bit error rate (BER), a transport block (TB) size, a packet delay budget (PDB), a QoS identifier, a QoS profile, a QoS rule, a QoS parameter index, a QoS parameter set index, a QoS parameter value, a QoS parameter range, a QoS parameter set corresponding to a specific traffic, a maximum TB size, a processing delay of UE, a transmission delay of UE, a power head of UE, a UE battery consumption parameter, UE hardware resource information, or a computing power information.

8. The method according to claim 1, wherein:
the UE uplink quality of service (QOS) information comprises at least one of the following: communication capability information of UE, expected QoS information, a QoS parameter that UE is capable of supporting, a deterministic level that UE is capable of providing, a deterministic capability that UE is capable of providing, QoS information of a specific traffic, or QoS information of a specific service.

9. The method according to claim 1, wherein:
the UE obtains the UE application layer information by at least one of the following:
the UE obtains the UE application layer information from a header field of a data packet in which the UE application layer information is carried;
the UE obtains the UE application layer information from a data field of a data packet in which the UE application layer information is carried;
the UE obtains the UE application layer information in a NAS message from a core network;
the UE obtains the UE application layer information through the application layer on the UE side, wherein the application layer delivers the application layer information to a NAS layer on the UE side;
the UE obtains the UE application layer information by the interface between the application layer and radio communication network;
the UE obtains the UE application layer information by the tunnel between the application layer and radio communication network;
the UE obtains the UE application layer information through the specific application layer packet from the application layer, wherein the specific application layer packet carries the application layer information; or
the UE obtains the UE application layer information through the specific application layer packet from the application layer, wherein the specific application layer packet comprises at least as following: application layer status information, application layer requirements for network layer, or application layer QoS request for network layer.

10. The method according to claim 1, wherein:
the UE information comprises the UE uplink quality of service (QOS) information; and
the UE uplink quality of service (QOS) information is corresponding to transmission resource of the UE determined by the base station, and the UE transmits data in response to the uplink QoS information on the transmission resource.

11-15. (canceled)

16. The method according to claim 1, further comprising:
after receiving data transmission control information configured and transmitted by the base station, performing, by the UE, at least one of the following:
taking the data transmission control information from the base station as the QoS information for the UE;
mapping a specific traffic to a specific radio bearer;
mapping a specific traffic to a specific logical channel;
mapping a specific traffic to a specific logical channel group;
mapping a specific traffic to one or more logical channels with a priority from the data transmission configuring information;
selecting a set of QoS parameters;
configuring one or more QoS parameters for the UE;
mapping a specific traffic to a resource indicated by a UL grant in response to a specific traffic identifier;
mapping a specific traffic to a resource of one or more HARQ IDs in response to a specific traffic identifier; or
mapping a specific traffic to a resource of a slot set in response to a specific traffic identifier.

17. (canceled)

18. The method according to claim 1, further comprising, before transmitting the UE information, performing, by the UE, at least one of the following:
transmitting, by the UE to the base station, a request for transmitting the UE information;
receiving, by the UE from the base station, a response for indicating the UE to transmit the UE information, wherein the response indicates resource allocated for the UE information transmission; or
transmitting, by the UE to the base station, the UE information on the resource indicated in the response.

19. A method for wireless communication, comprising:
receiving, by a base station, user equipment (UE) information from a UE, the UE information configured to assist the base station to configure data transmission, wherein the UE information comprises at least one of the following: UE transmission status information, UE uplink quality of service (QOS) information, or UE application layer information.

20. The method according to claim 19, further comprising:
configuring, by the base station, data transmission control information for the UE according to the UE information; and
transmitting, by the base station, the data transmission control information according to the UE information.

21. The method according to claim 19, further comprising:
receiving, by the base station, a request for transmitting the UE information from the UE;
allocating, by the base station, resource for the UE information transmission;
transmitting, by the base station, a response for indicating the UE to transmit the UE information, wherein the response comprises indicates the resource allocated for the UE information transmission; and
receiving, by the base station, the UE information on the resource indicated in the response.

22. The method according to claim 19, wherein the receiving, by the base station, the UE information from the UE comprises:
receiving, by the base station, the UE information from a core network, wherein the core network receives non-access stratum (NAS) signaling from the UE, the NAS signaling comprising the UE information, and the core network configured to transmit the UE information to the base station.

23. (canceled)

24. (canceled)

25. An apparatus comprising:
a memory storing instructions; and
at least one processor in communication with the memory, wherein, when the at least one processor executes the instructions, the at least one processor is configured to cause the apparatus to perform:
transmitting user equipment (UE) information to a base station, wherein the UE information comprises at least one of the following: UE transmission status information, UE uplink quality of service (QOS) information, or UE application layer information.

26. The apparatus according to claim 25, wherein, when the at least one processor executes the instructions, the at least one processor is configured to further cause the apparatus to perform:
receiving data transmission control information, wherein the data transmission control information is configured by the base station according to the UE information.

27. An apparatus comprising:
a memory storing instructions; and
at least one processor in communication with the memory, wherein, when the at least one processor executes the instructions, the at least one processor is configured to cause the apparatus to perform:
receiving user equipment (UE) information from a UE, the UE information configured to assist the apparatus to configure data transmission, wherein the UE information comprises at least one of the following: UE transmission status information, UE uplink quality of service (QOS) information, or UE application layer information.

28. The apparatus according to claim 27, wherein, when the at least one processor executes the instructions, the at least one processor is configured to further cause the apparatus to perform:
configuring data transmission control information for the UE according to the UE information; and
transmitting the data transmission control information according to the UE information.
